(19) United States
(12) Patent Application Publication
(10) Pub. No.: US 2025/0298214 A1
(43) Pub. Date: Sep. 25, 2025

(54) LENS ASSEMBLY

(71) Applicant: Japan Display Inc., Tokyo (JP)

(72) Inventors: Hirondo NAKATOGAWA, Tokyo (JP); Yoshiro AOKI, Tokyo (JP); Hitoshi TANAKA, Tokyo (JP)

(21) Appl. No.: 19/056,881

(22) Filed: Feb. 19, 2025

(30) Foreign Application Priority Data
Mar. 21, 2024 (JP) 2024-044837

(51) Int. Cl. G02B 7/02; G02F 1/1333; G02F 1/1335

(52) U.S. Cl. CPC G02B 7/021; G02F 1/133305; G02F 1/133526; G02B 2207/129

(57) ABSTRACT

The invention relates to a lens assembly using a LC coded aperture, and the configuration is as follows. A lens assembly including: a front lens element, having a first lens, placed on a first surface of a LC coded aperture; and a rear lens element having a second lens placed on a opposite surface of the LC coded aperture, the rear lens element being housed in a lens barrel, in which the rear lens element includes an upper surface and a side wall, the LC coded aperture is placed over an upper surface of the rear lens element, a flexible circuit board is connected to the LC coded aperture, a notch is formed in the wall of the rear lens element at a place corresponding to the flexible circuit board, which is pulled out to an outside through the notch from an upper part of the lens barrel.

### CLAIM OF PRIORITY

The present application claims priority from Japanese Patent Application JP 2024-044837 filed on Mar. 21, 2024, the content of which is hereby incorporated by reference into this application.

### BACKGROUND OF THE INVENTION

### (1) Field of the Invention

This invention relates to an imaging device which uses a coded aperture.

### (2) Description of the Related Art

Imaging with a camera is a process of capturing a two-dimensional image from a three-dimensional world. With a normal camera, the image at the focal point is clear, but as the distance from the focal point increases, the image becomes blurred.

On the other hand, there is a demand for full-screen display of clear images, or for obtaining 3D images. In order to realize such a demand, information on the distance between each position of the imaging object and the lens is required.

Non-patent document 1 describes a technique for measuring and calculating distance information while taking a camera shot, using a specially shaped coded aperture. Non-patent document 2 describes a technique for using a pair of patterns, one for preventing image blurring and the other for obtaining distance information, as a coded aperture.

### PRIOR ART DOCUMENTS

[Non-patent document 1] Image and Depth from a Conventional Camera with a Coded Aperture Anat Levin Rob Fergus et al.
[Non-patent document 2] Coded Aperture Pairs for Depth from Defocus and Defocus Deblurring Changyin Zhou Stephen Lin Shree K. Nayar

### SUMMARY OF THE INVENTION

There is a method of taking photographs using a specially shaped aperture pattern (hereafter it is also referred to as a coded aperture pattern) as an imaging technology that measures a distance from the lens to the subject and obtains distance data for forming a three-dimensional image or a fully focused image (it is also referred to as an all-in-focus image) simply by taking a photograph. In other words, this method is a method that makes it possible to calculate the distance from the lens to the pixel by taking a photograph using this coded aperture pattern.

If this coded aperture pattern is made up of liquid crystal devices, the degree of freedom in pattern formation can be greatly increased. Hereafter, this is also referred to as a liquid crystal coded aperture (LC coded aperture). Compared to a normal liquid crystal display device, an LC coded aperture has a feature of being extremely small in size. In addition, color images and gray displays are not necessary, and only black and white displays are required. In exchange, a clear difference between white and black displays is required. In other words, a large contrast between the display and black display is required.

The problem of this invention is to realize an LC coded aperture suitable for forming a coded aperture pattern.

This invention solves the above problem, and the main specific means are as follows.

(1) A lens assembly including: a front lens element having a first lens placed on a first surface of a liquid crystal coded aperture, and a rear lens element having a second lens placed on a second surface, which is opposite side to the first surface, of the liquid crystal coded aperture, the rear lens element being housed in a lens barrel; in which the rear lens element includes an upper surface and a side wall, the side wall of the rear lens element is housed in the lens barrel, the liquid crystal coded aperture is placed over an upper surface of the rear lens element, a flexible circuit board, which supplies electric signals and power, is connected to the liquid crystal coded aperture, a notch is formed in the wall of the rear lens element at a place corresponding to the flexible circuit board, and the flexible circuit board is pulled out to an outside through the notch from an upper part of the lens barrel.

(2) The lens assembly according to (1), in which the front lens element has a side wall, the side wall of the front lens element is housed in the side wall of the rear lens element, and the flexible circuit board is pull out to the outside through a space between the lens barrel and the side wall of the front lens element.

(3) The lens assembly according to (1), in which the front lens element is placed on the liquid crystal coded aperture.

### BRIEF DESCRIPTION OF THE DRAWINGS

FIG. 1 is an optical model of an imaging device using a lens;

FIG. 2 is an example of a coded aperture pattern;

FIG. 3 is another example of a coded aperture pattern;

FIG. 4 is a cross-sectional view of an imaging system using an aperture with a coded aperture pattern;

FIG. 5 is an example of a coded aperture pattern;

FIG. 6 is a cross-sectional view of FIG. 5;

FIG. 7 is a plan view showing the shape of the upper electrode;

FIG. 8 is a plan view showing the shape of the lower electrode;

FIG. 9 is a plan view showing an example of a divided lower electrode;

FIG. 10 is a plan view of a lens assembly using a comparative example;

FIG. 11 is a cross-sectional view of FIG. 10;

FIG. 12 is a plan view of a lens assembly according to Embodiment 1 before the front lens element is placed;

FIG. 13 is a cross-sectional view of FIG. 12 along the line C-C;

FIG. 14 is a plan view of lens assembly according to Embodiment 1; and

FIG. 15 is a cross-sectional view of FIG. 14 along the line D-D.

### DETAILED DESCRIPTION OF THE PREFERRED EMBODIMENT

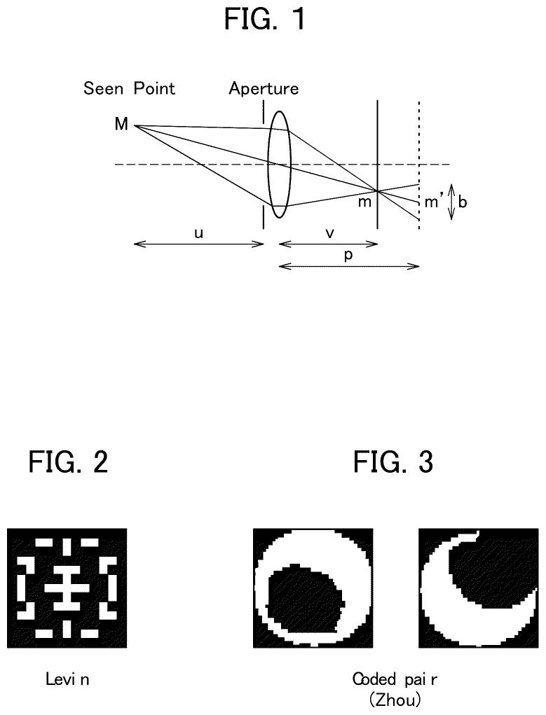

A camera is a means of capturing a three-dimensional image as a two-dimensional image. In order to reconstruct a 3D image or a full-focus image from this captured 2D image, it is necessary to know the distance from each imaging point to the center of the lens. FIG. 1 is an optical model of a camera using a lens. In FIG. 1, when an object at a distance u is measured using a lens with a focal length of f, all incident light is focused on a surface at v according to the lens law depicted in Equation 1.

$$1 / f = 1 / u + 1 / v \qquad [ Equation 1 ]$$

If the position p of the imaging surface coincides with v, a focused image is obtained, but if it is offset in back or forth, as depicted in Equation 2, the projected rays are projected as a circle of size b. This circle is sometimes called a diffraction circle.

$$B = a \vert v - p \vert / v \qquad [ Equation 2 ]$$

In Equation 2, “a” indicates the size of the aperture. If the size of “b” exceeds the size of the pixel, the image will be blurred. Because the depth of field of a camera is limited, objects at a distance from the focal point will be blurred in the image. As expressed in Equation 1 and Equation 2, the size of this blur depends on the distance from the camera to the object. Therefore, by measuring the blur, it is possible to estimate the distance from the camera to the object being imaged. This technique is called a depth from defocus (DFD) technique. Levin et al. proposed a pattern like the one in FIG. 2 as a coded aperture pattern for effectively measuring distance using the DFD technique.

By the way, the image captured by a camera is an image with various degradation factors added compared to a fully focused image (an ideal image with no blur in the entire screen; it is also referred to as an all-in-focus image). This degradation factor is expressed as the general blur function (point spread function: PSF). If the blur function is expressed as “k,” the captured image taken by the camera can be expressed as a convolution of the all-in-focus image “i” and the blur function “k,” as expressed in Equation 3.

$$J = k * i \qquad [ Equation 3 ]$$

In other words, the restoration of the all-in-focus image “i” can be achieved by deconvolution of the captured image “j.” Furthermore, since calculating the distance to each captured point is essential to obtaining the all-in-focus image “i,” it can be said that the restoration of the all-in-focus image is equivalent to the restoration of the distance from the center of the lens to the captured point.

Equation (4) is the inverse Fourier transform of Equation (3).

$$J = K \cdot I \qquad [ Equation 4 ]$$

Here, if the inverse function K⁻¹ of the PSF is known, then the frequency image I of the all-in-focus image can be obtained as expressed in Equation 5.

$$I = J / K \qquad [ Equation 5 ]$$

Then, by inverting I, it is possible to restore the all-in-focus image “i.” As mentioned earlier, restoring the all-in-focus image “i” is equivalent to measuring the distance from the center of the lens to each imaging point of the subject. When an image is taken through a coded aperture pattern 30, the influence of the coded aperture pattern 30 becomes dominant for the blur function (PSF).

By the way, the blur function k suitable for reproducing general all-in-focus images is different from the blur function k suitable for distance measurement using DFD technique. The blur function is determined by the coded aperture pattern 30. In order to reproduce all-in-focus images using accurate distance measurement, Zhou proposes using a pair of coded aperture patterns suitable for distance measurement using DFD technique and data for reproducing all-in-focus images, as depicted in FIG. 3.

In an imaging device that can perform distance measurement using DFD technique, or reproduce an all-in-focus image using distance data, or even reproduce a 3D image, it is required to be able to handle various coded aperture patterns, and when using multiple coded aperture patterns, it is required to have a structure that can switch patterns at high speed.

A purpose of the present invention is to realize a configuration that satisfies such requirements by using an LC coded aperture. It is also to realize a lens assembly that includes an LC coded aperture and is used in such a camera configuration.

### Embodiment 1

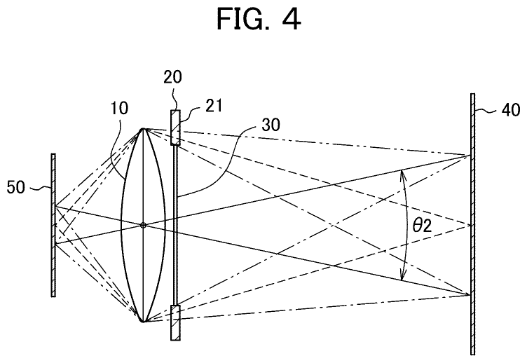

FIG. 4 is a cross-sectional view of a case where a subject 40 is photographed using a lens 10. In FIG. 4, the subject 40 is on the right side of the lens 10, and a light sensor 50, on which image is projected, is on the left side. From now on, the object to be photographed 40 will also be referred to as the subject 40. However, in this case, the subject 40 refers to a wide range of objects, including not only small objects but also the background surrounding these objects. The light sensor 50 uses a semiconductor image sensor such as a complementary metal oxide semiconductor image sensor (CMOS image sensor) or a charge coupled device image sensor (CCD image sensor).

In general, the refractive index of lens 10 increases as it moves away from the center. In addition, the spherical aberration increases as it moves away from the center of the lens. However, since FIG. 4 is a cross-sectional diagram for the purpose of explanation, the spherical aberration of lens 10 is ignored. The same applies to FIG. 4 and beyond.

In FIG. 4, the light that leaves the center of the subject 40, indicated by the dotted line, is refracted by the lens 10 and focused at the center of the light sensor (hereafter simply referred to as the sensor) 50. The light that leaves the upper edge of the subject 40, passing through the center of the lens 10, travels in a straight line and forms an image at the lower edge of the sensor 50, as indicated by the solid line. In addition, light that does not pass through the center of lens 10 and exits the upper part of the subject 40 is refracted by lens 10 as indicated by the dotted line, and forms an image at the lower part of sensor 50. On the other hand, light that passes through the center of lens 10 and exits the lower part of the subject 40 forms an image at the upper part of sensor 50 as indicated by the solid line. In addition, light that does not pass through the center of lens 10 and exits the lower part of subject 40 is refracted in lens 10 as indicated by the dotted line, and is imaged on the upper part of sensor 50.

In FIG. 4, an aperture 20 is placed between the lens 10 and the subject 40, close to the lens. This aperture has a coded aperture pattern 30. In addition, a second aperture 21 that regulates the amount of light passing through is located outside the coded aperture pattern 30. In this document, the coded aperture pattern 30 and the second aperture 21 are referred to as the aperture 20. Incidentally, the second aperture 21 is not essential. It is also possible to have the second aperture 21 perform its role by using the outer frame of the coded aperture pattern 30.

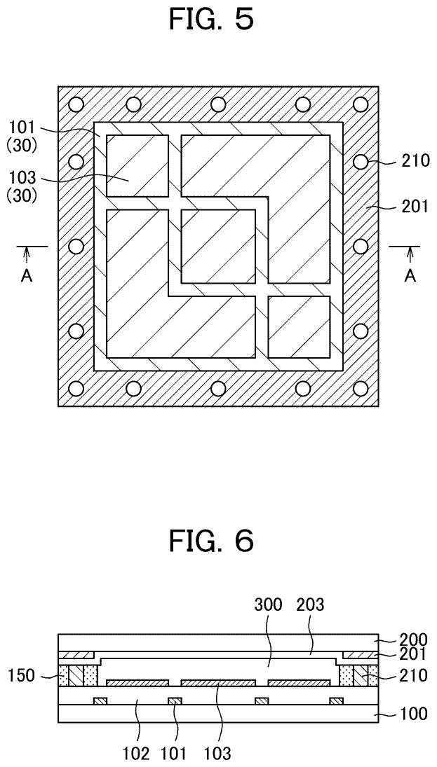

FIG. 5 is a plan view of the case where the aperture 20 is composed of an LC coded aperture. The LC coded aperture is composed of a thin-film transistor substrate (TFT substrate) with electrodes, etc. formed on it and an opposing substrate with light-shielding film, etc. formed on it, which are sealed together with sealing material around the perimeter, and liquid crystal arranged inside. In FIG. 5, a light-shielding film 201 is formed in a frame shape. The light-shielding film 201 is manufactured using the same material and process as the black matrix used in liquid crystal displays, etc. The light shielding film 201 is formed on the opposing substrate.

In addition, the opposing substrate has a common electrode formed on its surface. The pixel electrode, which is opposite to the common electrode, is formed on the TFT substrate. In FIG. 5, a pillar-shaped spacer 210 is arranged in the frame portion to define the distance between the TFT substrate and the opposing substrate, overlapping with the light shielding film 201.

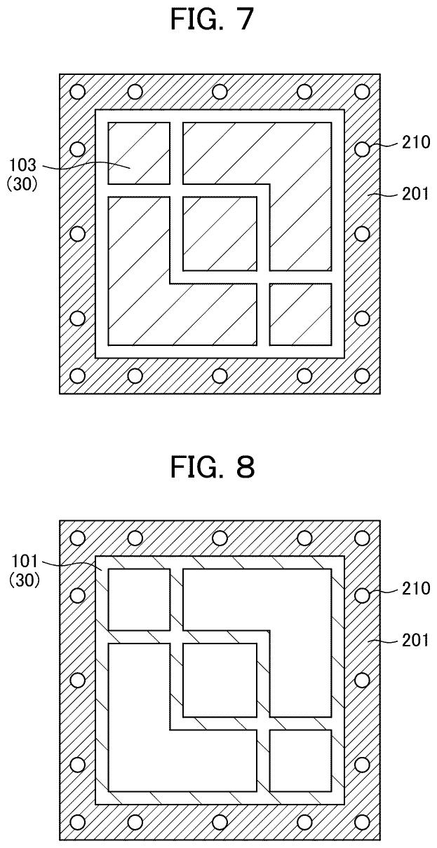

The coded aperture pattern 30 is formed inside the frame formed by the light shielding film 201. As explained in FIGS. 7 and 8, both a lower electrode 101 and an upper electrode 103 can form the coded aperture pattern 30. In FIG. 5, the lower electrode 101 and the upper electrode 103 are formed on the TFT substrate, with an insulating film in between, in order to display the coded aperture pattern 30. The lower electrode 101 and upper electrode 103 are fixed patterns. In FIG. 5, there is a relation that when the lower electrode 101 is ON, the upper electrode 103 is OFF, and when the lower electrode 101 is OFF, the upper electrode 103 is ON. This makes it possible to form two types of coded aperture patterns as needed.

FIG. 6 is a cross-sectional view of FIG. 5. In FIG. 6, a TFT substrate 100, on which the aperture pattern electrodes 101 and 103 are formed, is placed opposite to an opposing substrate 200, on which a common electrode 203 is formed, and a liquid crystal layer 300 is sandwiched between the TFT substrate 100 and the opposing substrate 200. The TFT substrate 100 and the opposing substrate 200 are bonded together around the perimeter using sealant 150. The distance between the TFT substrate 100 and the opposing substrate 200 is maintained using columnar spacers 210.

In FIG. 6, a lower electrode 101 is formed on the TFT substrate 100, and an interlayer insulating film 102 is formed to cover this, and an upper electrode 103 is formed on top of the interlayer insulating film 102. Depending on which electrode, the lower electrode 101 or the upper electrode 103, is given a voltage, the aperture pattern 30 formed will differ.

FIG. 7 depicts an example of a coded aperture pattern 30 formed when only the upper electrode 103 is turned on. The example in FIG. 7 is a combination of three rectangles and two L-shaped patterns. In FIG. 7, all five areas are turned on, but by turning off one or two or four of the patterns, a different coded aperture pattern 30 can be obtained.

FIG. 8 depicts an example of the coded aperture pattern 30 that is formed when only the lower electrode 101 is turned on. The example in FIG. 8 corresponds to the pattern in the gap in FIG. 7. The lower electrode depicted in FIG. 8 has a complex pattern like this, but it is possible to form various patterns by partially electrically dividing it.

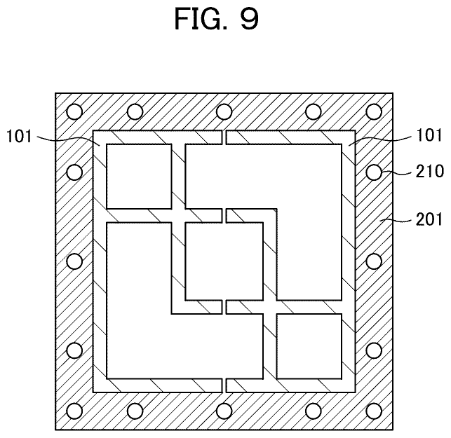

FIG. 9 depicts an example of the pattern in FIG. 8 divided into left and right sides. By using either of the patterns, it is possible to form different coded aperture patterns 30. The width of the divided section should be as small as possible, as long as electrical insulation is maintained. This is because if the width is too large, there is a risk of light leakage.

The patterns depicted in FIGS. 5, 7, and 9 are just examples. By freely changing the shape of the upper electrode 103 and the lower electrode 101, various types of coded aperture patterns 30 can be formed. However, in order to prevent light leakage, the gap formed by the upper electrode 103 should be covered by the lower electrode 101 when viewed in a plane.

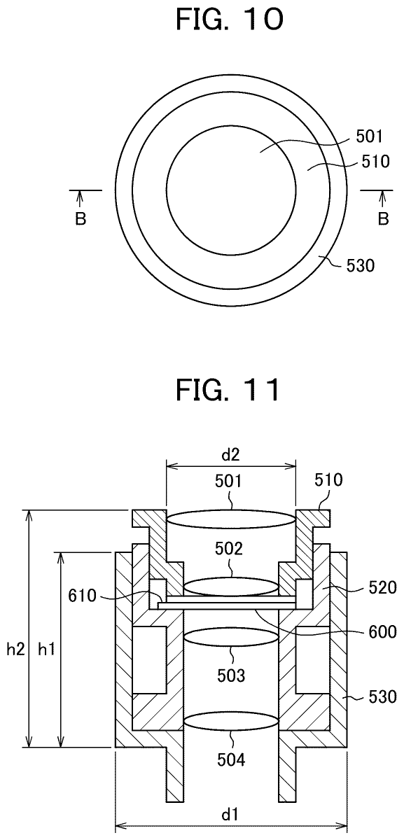

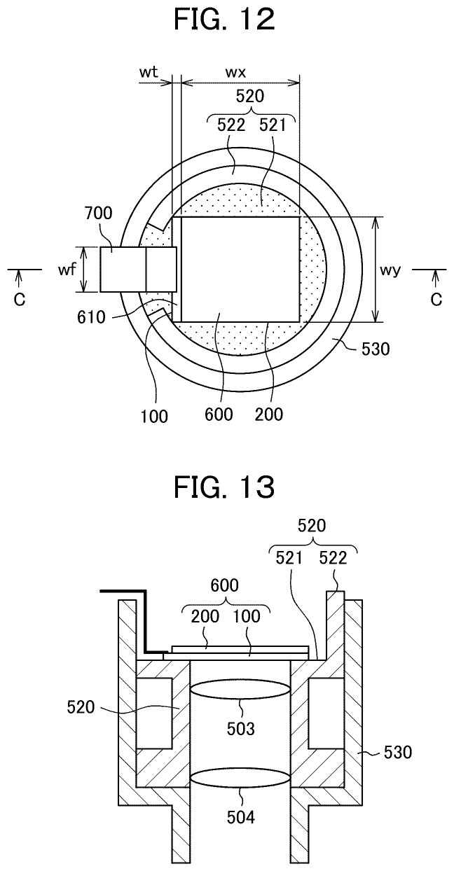

FIGS. 10 and 11 are specific lens and LC coded aperture assemblies as comparative examples. Hereafter, including FIGS. 12 to 15, such assembly of an LC coded aperture and a lens is referred to as a lens assembly. FIG. 10 is a plan view of the lens assembly from above, and FIG. 11 corresponds to the B-B cross-sectional view of FIG. 10. By the way, since FIG. 4 is a schematic diagram for explanation, a single lens is used as a representative. However, in actuality, multiple lenses are used for aberration correction and other purposes.

In FIG. 11, above the LC coded aperture, two lenses 501 and 502 are arranged at a distance in a metal container called a front lens element 510. These lenses are sometimes called front lenses. Below the LC coded aperture, two lenses 503 and 504 are arranged at a distance in a metal container called a rear lens element 520. These lenses are sometimes called rear lenses. The lenses 501, 502, 503, 504, etc. are formed of glass, for example. The rear lens element 520 is housed in a metal lens barrel 530. The front lens element 510 is housed in the side wall of rear lens element 520.

As an example of dimensions, the following applies. The outer diameter d1 of the lens barrel 530 is, for example, 40 mm, and the height h1 of the lens barrel 530 is 40 mm. The aperture diameter d2 of the front lens element 510 is, for example, 30 mm, and the height h2 from the bottom surface of the lens barrel 530 to the top surface of the front lens element 510 is, for example, 50 mm.

As depicted in FIG. 10, the overall plan view of the lens assembly is a circle. However, an LC coded aperture 600 is, for example, a rectangle, as depicted in FIG. 12. The dimensions of the LC coded aperture 600, etc., are explained in FIG. 12, etc.

As explained in FIGS. 5 to 9, the aperture pattern of the LC coded aperture 600 is determined by supplying a signal from the outside. However, in the configuration of FIGS. 10 and 11, it is not possible to supply an electrical signal to the LC coded aperture 600.

FIGS. 12 to 15 depict the lens assembly configuration of Embodiment 1, which solves the above-mentioned problems. The general configuration of Embodiment 1 is to form a cutout in a part of the side wall of the rear lens element in which the LC coded aperture 600 is placed, and to pull a flexible printed circuit board 700 connected to the LC coded aperture 600 along the inside of the lens barrel 530 through this cutout part to the outside. After that, the front lens element 510 is inserted into the rear lens element 520 in the same way as in FIGS. 10 and 11. With this configuration, it is possible to maintain the basic configuration and the manufacturing process of the comparative example depicted in FIGS. 10 and 11 without causing light leakage.

FIGS. 12 and 13 depict the plan view and cross-sectional view of the configuration before the front lens element 510 is inserted in Embodiment 1. FIG. 13 corresponds to the C-C cross-sectional view of FIG. 12. In FIG. 12, the rear lens element 520 is housed in the lens barrel 530, and the LC coded aperture 600 is placed on the flat surface of the rear lens element 520.

The LC coded aperture 600 has a rectangular shape, and as explained in FIG. 6, it is configured with the TFT substrate 100 and the opposing substrate 200 arranged opposite each other, with the liquid crystal 300 arranged between them. The effective area for forming the coded aperture pattern is formed in the overlapping area of the TFT substrate 100 and the opposing substrate 200 overlap, the effective area being formed to create the aperture pattern. The TFT substrate 100 is formed larger than the opposing substrate 200, and a terminal area 610 is formed in the area where the TFT substrate 100 does not overlap with the opposing substrate 200. The flexible circuit board 700 is connected to this terminal area 610, and is drawn out to the outside, and the LC coded aperture 600 is supplied with electrical signals and power.

The following are examples of dimensions related to the LC coded aperture 600. For example, the dimensions of the area where the TFT substrate 100 and the opposing substrate 200 overlap to form the effective area are square, and wx and wy are approximately 25 mm. The width wt of the terminal area 610 to which the flexible circuit board 700 is connected is, for example, approximately 2.5 mm. The width wf of the flexible circuit board 700 is, for example, 10 mm. In the LC coded aperture 600, the thickness of the TFT substrate 100 and the opposing substrate 200 is, for example, approximately 0.5 mm.

As depicted in FIG. 12, the side wall 522 of the rear lens element 520 is cut out in correspondence with the part where the flexible printed circuit board 700 is connected, and as depicted in FIG. 13, it is possible to pull the flexible printed circuit board 700 outwards along the lens barrel 530.

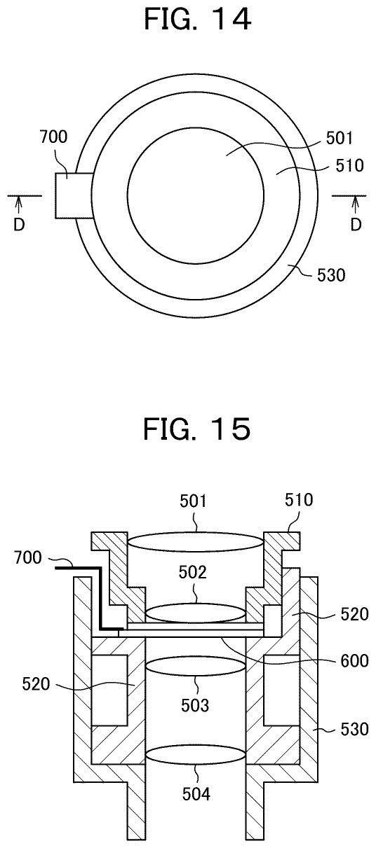

FIGS. 14 and 15 depict the state of the front lens element 510 inserted into the configuration of FIGS. 12 and 13, and are a plan view and a cross-sectional view of the configuration of Embodiment 1. FIG. 15 corresponds to the D-D cross-sectional view of FIG. 14. As depicted in FIG. 14, the LC coded aperture 600 is covered by the front lens element 510, which has a lens 501. However, the flexible printed circuit board 700 connected to the LC coded aperture 600 is pulled out from the top end of the lens barrel 530 to the outside.

In FIG. 15, the side wall 522 of the rear lens element 520 where the flexible circuit board 700 is present is notched, but this part is covered by the side wall of the front lens element 510, therefore, the light-shielding effect is sufficiently maintained. The feature of FIG. 15 is that the front lens element 510 has a side wall, and the side wall of the front lens element 510 and the side wall of the lens barrel 530 have an overlapping part. This improves the effect of preventing light leakage.

The features of the present invention are as follows. The LC coded aperture 600 may be replaced with a LC coded aperture 600 having a different pattern as necessary. According to the configuration of the present invention as explained above, the LC coded aperture 600 can be replaced simply by removing the front lens element 510.

By the way, the patterns formed on the LC coded aperture 600 depicted in FIGS. 5 to 9 are examples, and various aperture patterns can be formed depending on the electrode shape formed on the TFT substrate 100. In addition, the aperture patterns depicted in FIGS. 5 to 9 are fixed patterns formed by fixed electrodes, but for example, the configuration can be made such that any shape of aperture pattern can be formed by making the electrode formed on the TFT substrate 100 side in a matrix-shaped pixel electrode.

What is claimed is:

1. A lens assembly comprising:
a front lens element having a first lens placed on a first surface of a liquid crystal coded aperture, and
a rear lens element having a second lens placed on a second surface, which is opposite side to the first surface, of the liquid crystal coded aperture,
the rear lens element being housed in a lens barrel;
wherein the rear lens element includes an upper surface and a side wall,
the side wall of the rear lens element is housed in the lens barrel,
the liquid crystal coded aperture is placed over an upper surface of the rear lens element,
a flexible circuit board, which supplies electric signals and power, is connected to the liquid crystal coded aperture,
a notch is formed in the wall of the rear lens element at a place corresponding to the flexible circuit board, and
the flexible circuit board is pulled out to an outside through the notch from an upper part of the lens barrel.

2. The lens assembly according to claim 1,
wherein the front lens element has a side wall, the side wall of the front lens element is housed in the side wall of the rear lens element, and
the flexible circuit board is pull out to the outside through a space between the lens barrel and the side wall of the front lens element.

3. The lens assembly according to claim 1,
wherein the front lens element is placed on the liquid crystal coded aperture.

4. The lens assembly according to claim 1,
wherein the first lens includes a plurality of lenses.

5. The lens assembly according to claim 1,
wherein the second lens includes a plurality of lenses.

6. The lens assembly according to claim 1,
wherein an electrode of the liquid crystal coded aperture has a fixed electrode for forming a coded aperture pattern.

7. The lens assembly according to claim 1,
wherein the front lens element, the rear lens element, and the lens barrel have a circular shape, and the liquid crystal coded aperture has a rectangular shape in a plan view.

8. The lens assembly according to claim 1,
wherein the front lens element, the rear lens element, and the lens barrel are formed by metal, and the liquid crystal coded aperture is formed by glass.
